(19) United States
(12) Patent Application Publication
(10) Pub. No.: US 2026/0017302 A1
(43) Pub. Date: Jan. 15, 2026

(54) METHODS AND SYSTEMS FOR UPDATING A RETRIEVAL-AUGMENTED GENERATION FRAMEWORK

(71) Applicant: Shopify Inc., OTTAWA (CA)

(72) Inventors: STEPHEN PRATER, PORTLAND, OR (US); MATTHEW RATZLOFF, PORTLAND, OR (US); ROBERT THORNTON, OTTAWA (CA)

(21) Appl. No.: 18/770,394

(22) Filed: Jul. 11, 2024

(51) Int. Cl. G06F 16/33; G06F 16/383

(52) U.S. Cl. CPC G06F 16/3347; G06F 16/3344; G06F 16/383

(57) ABSTRACT

There is provided a computer method, system and device comprising detecting an updated iteration of a document for query response generation; comparing the updated iteration to a prior iteration to identify chunks of the updated iteration of the document that differ from corresponding chunks of the prior iteration, the prior iteration for generating a set of synthetic questions and answers using an LLM. Responsive to identifying that a given chunk of the updated iteration differs from a corresponding chunk of the prior iteration, the method triggers generation, using the LLM, of a new set of synthetic questions associated with corresponding text in the given chunk defining a new set of synthetic responses, and wherein the new set of synthetic questions and responses replaces at least a subset of the set of synthetic questions and answers associated together by a mapping with the corresponding chunk of the prior iteration.

### FIELD

The present disclosure relates to machine learning and large language models (LLMs), and, more particularly, to retrieval-augmented generation (RAG), and, yet more particularly, to maintaining and continuously updating synthetic question answer (QA) pairs in a RAG pipeline applied to LLM systems.

### BACKGROUND

A large language model (LLM) is a type of machine learning (ML) model that can process natural language to summarize, translate, predict and generate text and other content. An LLM may be trained to learn billions of parameters to model how words relate to each other in a textual sequence. Inputs to an LLM may be referred to as prompts. A prompt is a natural language input that includes instructions to cause the LLM to generate a desired output, including natural language text or other generative output in various desired formats.

Retrieval Augmented Generation (RAG) is a process for optimizing the output of an LLM, by referencing a knowledge base (i.e., a database of documents that contain useful information) or other external sources that are outside the LLM training data sources, prior to generating a response.

A chatbot is a type of artificial intelligence that typically provides assistance to a user via a conversational interaction. Some chatbots make use of LLMs to carry out user interactions. Chatbots may also be referred to as virtual assistants, conversational agents, or smart assistants.

Synthesizing QA pairs for data augmentation presents technical challenges as the quality of the generated QA pairs can vary significantly and its use scenario dependent thereby may cause harm rather than improvement. The generation and management of synthetic QA pairs is a computationally complex task.

### SUMMARY

Retrieval-augmented generation (RAG) is an A1 framework used by search engines or LLM-based chatbots to improve the quality of generated responses. Rather than relying on the knowledge inherent to the LLM at the time it was trained (e.g., the knowledge contained in the dataset on which the LLM was trained), a RAG-based engine retrieves data from internal sources (e.g., a knowledge base) and/or external sources (e.g., public data accessible via the Internet) to improve the quality of response generation, for example, to help ensure that the LLM is drawing from accurate and up-to-date information and enabling the LLM to include a source for the information provided in the generated output. Conventionally, virtual assistants (also referred to as chatbots) or existing search methods employing the RAG framework often have access to a database of stored documents and corresponding document embeddings, to assist in generating responses. In response to a user input (e.g., a query or a search request), the chatbot or search engine may encode the user input into an input embedding and perform a vector similarity search to identify, based on similarity of the corresponding embeddings, documents that are deemed relevant to the user input. Identified document(s) are then retrieved from the database and used as additional input to the LLM to generate a response to the user input.

In various examples, the present disclosure provides a technical solution for implementing a RAG-based framework that addresses at least some of the above drawbacks. Examples of the disclosed RAG-based engine enable more accurate identification of relevant sources for use in response generation by an LLM. The disclosed RAG-based engine more effectively narrows the pool of potential source documents based on a similarity of a user input embedding (i.e., an embedding encoded based on a user input for example, an embedding encoded from an updated user input that has been automatically rephrased in the form of a question) to a synthetic question embedding, enabling the retrieval of more relevant source documents to be used by the LLM to generate an output in response to the user input. This provides a technical advantage in that the LLM is provided with more relevant information to enable the LLM to generate appropriate output thereby reducing the unnecessary consumption of computing resources (e.g. processing power, memory, computing time, etc.) associated with performing multiple iterations of prompting to achieve a desired result from the LLM.

Examples of the disclosed RAG-based engine may improve the performance of e-commerce platforms or merchant websites by presenting an improved help center or knowledge base experience to users. Examples of the disclosed technical solution leverage the semantic understanding capabilities of an LLM to formulate more accurate and relevant synthetic questions, thereby improving the accuracy and efficiency of document retrieval and response generation.

Examples of the disclosed RAG based LLM engine, as disclosed herein, may further enhance the performance, usability and relevance of the synthetic question answer pairs (QA) pairs thereby improving the efficacy of LLM applications to which the QA pairs are applied to for context to the LLM by intelligently updating synthetic question answer pairs as the knowledge documents or domain specific knowledge sources are updated.

Generally, retrieval-augmented generation may enhance the performance of large language models by using an external knowledge database or external source of data (e.g. data which is outside the initial training data used for the LLM model) at the inference stage. For example, the RAG may integrate searching into LLM text response generation such that upon receiving a user query or prompt, it retrieves external information to the model's input, such as context data from a database that is then included with the user prompt to improve the prompt by containing context information not previously available to the LLM. RAG based frameworks applied to LLMs perform much better than regular LLMs. Such RAG based LLM models can also update their knowledge by changing the information in the database they use for retrieval. Such RAG LLMs can even provide citations to show where within the retrieved context their output was derived from, making it easier for users to check and evaluate the predictions.

The main systems used to provide this extra information for RAG LLMs are vector databases and feature stores. RAG works well with LLMs because these models are good at learning from the context they're given. Because LLMs have limitations in that they are unable to learn over time, RAG aims to address these limitations by incorporating a vector database or feature store which provides real time context data to prompts.

Put another way, in the context of retrieval augmented generation, the output of large language models (LLMs) may be ‘grounded’ by conducting a search of a knowledge base or external source of data outside the LLMs initial training data and subsequently including resulting search results in the prompt to the language model. In some examples, the language model may be used to provide a help center chatbot assistant that responds to user queries. When a user expresses an issue or a query, the system typically executes a search of a knowledge base to find relevant sources of information to provide to the language model as context for responding to the user.

Referring to U.S. patent application Ser. No. 18/588,583, entitled: “METHODS AND SYSTEMS FOR RETRIEVAL-AUGMENTED GENERATION USING SYNTHETIC QUESTION EMBEDDINGS”, the disclosure of which is incorporated by reference herein in its entirety, a problem with existing knowledge base searches was identified. Notably, by transforming information in the external data stores into synthetic question/answer pairs and rephrasing the user prompt into a phrased question and subsequently computing vector similarity algorithms on the embeddings of the user question and embedding of the synthetic QA pairs, this improves accuracy of document retrieval and response generation.

When leveraging the LLM to formulate more accurate synthetic QA pairs to retrieve relevant information from knowledge documents and provide personalized answers to user queries based on the identified sections of the document, one of the technical issues faced is how to effectively update and manage and update these QA pairs when the source knowledge document changes over time (e.g. an online blog or FAQ, etc.). Such source documents may include documents from the external data stores used at inference time to formulate the QA pairs. Determining when and how to update the QA pairs to augment the RAG LLMs while not wasting computing resources is a complex computational challenge.

The proposed systems and methods are configured to continuously update question answer (QA) pairs in a RAG pipeline by intelligently determining changes between various iterations or versions of knowledge documents used to generate the QA pairs for enhancing the LLM responses to queries. Such determination of changes may include, in one or more aspects, determining changes in original and modified chunk pairs of the knowledge document versions and associated with generating the QA pairs. In some cases, updating the QA pairs based on determination of chunks of data having been updated in a new version of the knowledge document, may further include referencing citations to link QA pairs to their source chunks such as to utilize such citations to easily locate and update the QA pairs once a source chunk is determined as modified. In this manner, the dynamic and intelligent updating of the QA pairs in a RAG based framework, aims to perform in a resource efficient manner the process of optimizing the output of an LLM. Thus, this dynamic approach to updating the QA pairs within a RAG framework further extends the powerful capabilities of LLM to specific domains without the need to retrain the LLM model.

In one or more implementations, the proposed methods and systems further conveniently leverage the advantages of the RAG framework applied to an LLM (e.g. such as that provided in U.S. patent application Ser. No. 18/588,583, incorporated herein in its entirety by reference) while maintaining the accuracy of the method of matching user input, such as that provided within a chatbot or other query interface, to information in the knowledge base such as by keeping the synthetic QA pairs continuously updated via monitoring changes to the knowledge source document(s) and triggering updating of the QA pairs in an intelligent manner. Notably, the proposed computing methods and systems conveniently reduce unnecessary computing resources by removing the need to regenerate all QA pairs associated with a modified document and rather focuses on the changed segments or chunks of the document to generate new QA pairs therefrom.

In some examples, the present disclosure describes a computer implemented method. The method includes a number of steps, including: detecting an updated iteration of a document for augmenting query response generation; comparing the updated iteration of the document to a prior iteration of the document to identify chunks of the updated iteration of the document that differ from corresponding chunks of the prior iteration of the document, the prior iteration for generating a set of synthetic questions and answers using an LLM; and responsive to identifying that a given chunk of the updated iteration of the document differs from a corresponding chunk of the prior iteration of the document, triggering generation, using the LLM, of a new set of synthetic questions associated with corresponding text in the given chunk providing a new set of synthetic responses, and wherein the new set of synthetic questions and responses replaces at least a subset of the set of synthetic questions and answers associated together by a mapping of the given chunk with the corresponding chunk of the prior iteration of the document.

In at least one aspect, the method further comprises: applying the new set of synthetic questions and synthetic responses to the LLM to generate a response to a user query.

In at least one aspect, generating the response further comprises: applying the LLM to generate a textual response to the user query responsive to identifying a similarity to at least one of the set of synthetic questions and corresponding answers and the new set of synthetic questions and responses.

In at least one aspect, triggering generation is further based upon detecting a degree of difference between the corresponding chunk and the given chunk exceeds a defined threshold.

In at least one aspect, responsive to detecting the difference, further applying semantic similarity using natural language processing to determine a similarity measure and specific segments of text within the given chunk which are modified compared to the corresponding chunk in the prior iteration and triggering the generation of the new set of synthetic questions and responses for the specific segments of text.

In at least one aspect, the method further comprises prior to performing a comparison, performing an initial checksum on entire textual content of the updated iteration of the document to determine whether an update exists in textual content of the document as a whole and based on said determining, computing a hash on each chunk of the updated iteration at a time and comparing it to corresponding chunks of the prior iteration to determine differing chunks for generating the new set of synthetic questions and responses therefrom.

In at least one aspect, the degree of difference is based on at least one of a distance measure or a cosine similarity.

In at least one aspect, the method further comprises providing a user interface configured to receive a user query and, in response, determining a similarity between the user query and the set of synthetic questions and the new set of synthetic questions to retrieve corresponding synthetic responses for providing the textual response to the user query and displaying the textual response on a visual display of the user interface.

In at least one aspect, the method further comprises: initially performing content aware chunking on the updated iteration and prior iteration of the document by accessing document metadata comprising document structure relationships providing at least one of section headers, subheaders and document boundaries, and chunking based on the document structure relationships, the chunking for identifying differing chunks between the updated iteration and prior iteration.

In at least one aspect, chunking based on the document structure relationships, further comprises, prior to performing the chunking, determining, via natural language processing, whether one or more sentences corresponding to a prior chunk and preceding a current chunk has a similar context and thereby merging the prior chunk and the current chunk into a single chunk for comparing between iterations.

In at least one aspect, generating the textual response to the user query comprises: generating a prompt to the LLM, the prompt including the user query and relevant set of question and answer pairs comprising: at least one of the set of synthetic questions and corresponding answers; and the new set of synthetic questions and responses; and, providing the prompt to the LLM and receiving the generated textual response.

In at least one aspect there is provided a computer system comprising: a processing unit configured to execute computer readable instructions to cause the computer system to: detect an updated iteration of a document for augmenting query response generation; compare the updated iteration of the document to a prior iteration of the document to identify chunks of the updated iteration of the document that differ from corresponding chunks of the prior iteration of the document, the prior iteration for generating a set of synthetic questions and answers using an LLM; and responsive to identifying that a given chunk of the updated iteration of the document differs from a corresponding chunk of the prior iteration of the document, trigger generation, using the LLM, of a new set of synthetic questions associated with corresponding text in the given chunk providing a new set of synthetic responses, and wherein the new set of synthetic questions and responses replaces at least a subset of the set of synthetic questions and answers associated together by a mapping of the given chunk with the corresponding chunk of the prior iteration of the document.

In at least some aspects, there is provided a non-transitory computer-readable medium storing instructions that, when executed by a processing unit of a computing system, cause the computing system to: detect an updated iteration of a document for augmenting query response generation; compare the updated iteration of the document to a prior iteration of the document to identify chunks of the updated iteration of the document that differ from corresponding chunks of the prior iteration of the document, the prior iteration for generating a set of synthetic questions and answers using an LLM; and responsive to identifying that a given chunk of the updated iteration of the document differs from a corresponding chunk of the prior iteration of the document, trigger generation, using the LLM, of a new set of synthetic questions associated with corresponding text in the given chunk providing a new set of synthetic responses, and wherein the new set of synthetic questions and responses replaces at least a subset of the set of synthetic questions and answers associated together by a mapping of the given chunk with the corresponding chunk of the prior iteration of the document.

In some examples, the computer-readable medium may store instructions that, when executed by the processor of the computing system, cause the computing system to perform any of the methods described above.

These and other aspects will be apparent to those of ordinary skill in the art.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3 is a block diagram illustrating an example RAG-based engine for dynamic updating and management of question-answer (QA) pairs to augment LLMs, in accordance with example embodiments of the present disclosure.

FIG. 4 is a schematic diagram illustrating an example flow and structure of updating QA pairs for an updated knowledge document in a RAG framework, in accordance with example embodiments of the present disclosure.

FIG. 5 is a flowchart illustrating an example method for operation of a question answer (QA) engine of an example RAG-based engine, in accordance with examples of the present disclosure.

FIG. 6 is a flowchart illustrating an example method for operation of an example RAG-based engine, in accordance with examples of the present disclosure.

Similar reference numerals may have been used in different figures to denote similar components.

### DETAILED DESCRIPTION

In various examples, the present disclosure describes methods and systems for implementing a retrieval augmented generation (RAG) based engine, enabled to determine changes in original and modified chunk pairs of knowledge source documents relevant to a question or task and thereby updating question and answer pairs (QA) pairs in an intelligent and dynamic manner to provide them as context to an LLM. The RAG-based engine generates prompts to a large language model (LLM), including the user input and an identified relevant source text, and receives output from the LLM to more efficiently generate output that may assist a user in solving a problem or answering a question.

This provides a technical advantage in that the LLM is provided with more relevant information to enable the LLM to generate appropriate output in fewer iterations thereby reducing the unnecessary consumption of computing resources (e.g., processing power, memory, computing time, etc.) to achieve a desired result from the LLM.

The proposed systems and methods are configured to continuously update question answer (QA) pairs in a RAG pipeline by intelligently determining changes between various iterations or versions of knowledge documents used to generate the QA pairs for enhancing the LLM responses to queries. Such determination of changes may include, in one or more aspects, determining changes in original and modified chunk pairs of the knowledge document versions and associated with generating the QA pairs. In some cases, updating the QA pairs based on determination of chunks of data having been updated in a new version of the knowledge document, may further include referencing citations to link QA pairs to their source chunks such as to utilize such citations to easily locate and update the QA pairs once a source chunk is determined as modified. In this manner, the dynamic and intelligent updating of the QA pairs in a RAG based framework, aims to perform in a resource efficient manner the process of optimizing the output of an LLM. Thus, this dynamic approach to updating the QA pairs within a RAG framework further extends the powerful capabilities of LLM to specific domains without the need to retrain the LLM model.

In some aspects, original and modified chunk pairs may refer to two segments of text. The original chunk may be a segment of text that is a specific passage from a source or knowledge document. The modified chunk may be another segment of text that is an altered version of the specific passage. Such alteration may, for example, include (but is not limited to) one or more of simplifying language, rephrasing for clarity, and/or updating textual/other information while generally retaining or preserving at least some of the context or core meaning of the text of the original chunk. Notably, in at least some aspects, the original and modified chunks have been described as “pairs”, this may simply denote that the original and associated modified chunk may notionally be considered to be a tuple, rather than an indication that a particular type of mapping, reference or correlation may exist or be maintained between the original and modified chunks in memory or storage in a given implementation. Put another way, the term “pair” may be considered to, in at least some cases, denote some manner of correspondence or linking between a given original chunk and a corresponding modified chunk. Such correspondence may be maintained in memory or storage in at least some implementations, for example, the original and modified chunks can be mapped, referenced, or otherwise linked to one another. Such pairs may, as further described below be used to create Question-Answer (QA) pairs based on a dynamic knowledge document which may change over time. Notably, by maintaining some manner of a mapping between an original segment of text and a corresponding modified version in one or more databases and computing systems described herein e.g. may enable maintenance, traceability and/or consistency in information delivery across various contexts over time.

In one or more implementations, the proposed methods and systems further conveniently leverage the advantages of the RAG framework applied to an LLM (e.g. such as that provided in U.S. patent application Ser. No. 18/588,583, incorporated herein in its entirety by reference) while maintaining the accuracy of the method of matching user input, such as that provided within a chatbot or other query interface, to information in the knowledge base such as by keeping the synthetic QA pairs continuously updated via monitoring changes to the knowledge source document(s) and triggering updating of the QA pairs in an intelligent manner. Notably, the proposed computing methods and systems conveniently reduce unnecessary computing resources by removing the need to regenerate all QA pairs associated with a modified document and rather focusing on the changed segments or chunks of the document in particular to generate new QA pairs therefrom rather than regenerating QA pairs from scratch on the whole modified document.

Examples of the disclosed RAG-based engine may improve the performance of e-commerce platforms or merchant websites by presenting an improved help center or knowledge base experience to users. Examples of the disclosed technical solution leverage the semantic understanding capabilities of an LLM to formulate more accurate and relevant synthetic questions, thereby improving the accuracy and efficiency of document retrieval and response generation.

As will be discussed further below, examples of the disclosed RAG based engine may send prompts to and receive output from an LLM, which is a type of deep neural network.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others. DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label) or may be unlabeled.

Training a ML model generally involves inputting into a ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted to lower the output value in future training iterations. An objective function is a way to quantitatively represent how close the output value is to the target value. An objective function represents a quantity (or one or more quantities) to be optimized (e.g., minimize a loss or maximize a reward) to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

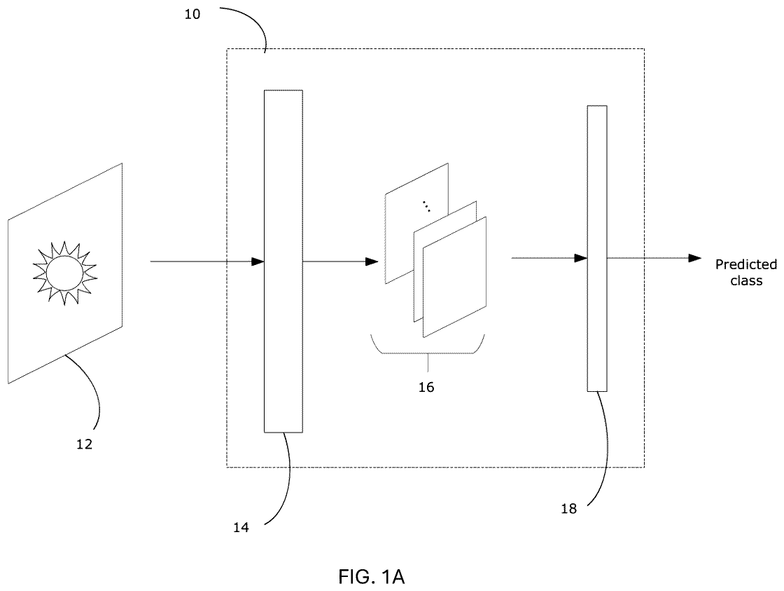

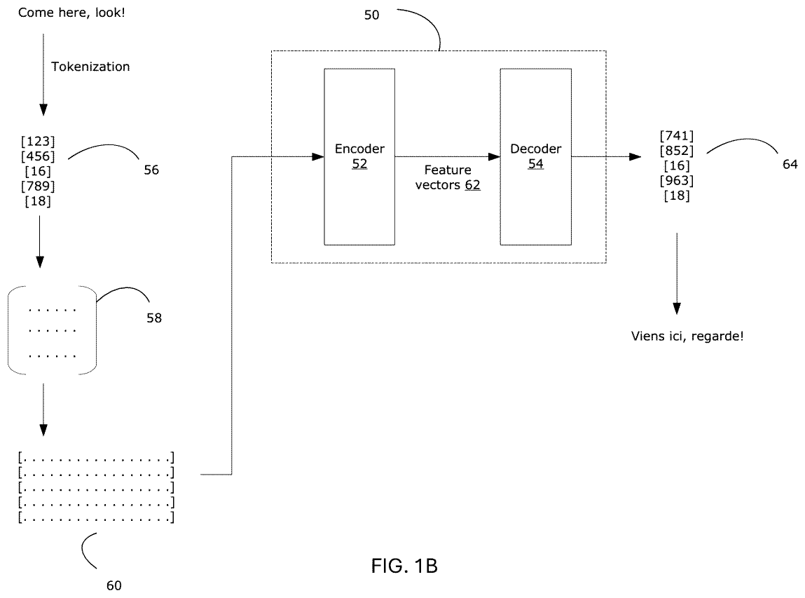

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some preprocessing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

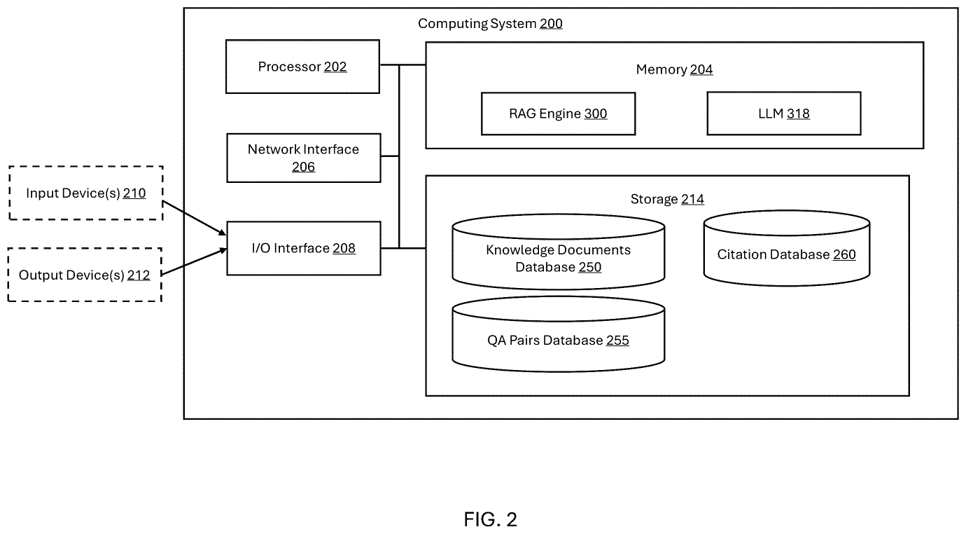

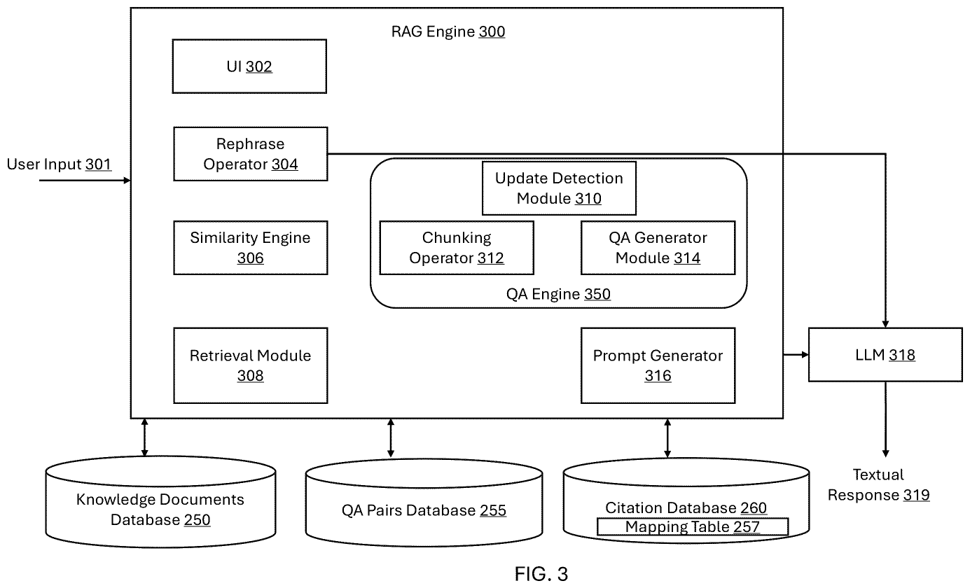

FIG. 2 illustrates an example computing system 200, which may be used to implement examples of the present disclosure. For example, the computing system 200 may be used to generate a prompt to an LLM to cause the LLM to generate output that includes a textual response as disclosed herein. Additionally or alternatively, one or more instances of the example computing system 200 may be employed to execute the LLM. For example, a plurality of instances of the example computing system 200 may cooperate to provide output using an LLM in manners as discussed above. Additionally, one or more instances of the example computing system 200 of FIG. 2 and corresponding modules of FIG. 3 may cooperate to provide a RAG based engine for LLM that automatically generates a textual response to a query provided via user input (e.g. via a chatbot), in a manner that retrieves updated relevant source content from knowledge documents for augmenting the LLM, and dynamically updates the relevant modules, such as the RAG engine 300 to generate more effective synthetic question answer pairs used to augment the LLM when the source knowledge documents accessed by the RAG are updated. As will be described with reference to FIGS. 2 and 3, the computing system 200 may be used to leverage the semantic understanding capabilities of an LLM (e.g. LLM 318) to formulate more accurate and relevant synthetic question and answer pairs based on intelligently updating the QA pairs upon detecting an update to the knowledge document from which the QA pairs are derived thereby improving the accuracy of document retrieval and response generation provided by the computing system 200. In one or more aspects, the computing system 200 may specifically hone in on portions or chunks of the source knowledge document which have been updated during a chunking process and then trigger the LLM (e.g. LLM 318) to generate new QA pairs (e.g. to be stored in a synthetic QA pairs database 255) for the updated chunks only (rather than the article as a whole), thereby generating more relevant QA pairs which reflect the update to the knowledge document (e.g. as stored in the knowledge documents database 250) specifically. The new QA pairs (which may be stored in the synthetic QA pairs database 255) for the modified chunks are then used to replace the QA pair for the corresponding original chunk and then merged with the remaining original QA pairs for the remainder of the article or knowledge document held within knowledge documents database 250.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, in a message (e.g., in a payload of a message).

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a RAG engine 300, which may include a user interface (UI) 302, a rephrase operator 304, a similarity engine 306, a retrieval module 308, an update detection module 310, a chunking operator 312, a QA generator module 314, a prompt generator 316 communicating with one or more databases including a knowledge documents database 250, a QA pairs database 255, a citations database 260 described with respect to FIG. 3 below.

In some examples, the computing system 200 may be a server of an online platform that provides the RAG-based engine 300 as a web-based or cloud based service that may be accessible by a user device (e.g., via communications over a wireless network). Other such variations may be possible without departing from the subject matter of the present application.

The computing system 200 may also include a storage unit 214, which may include a mass storage unit such as a solid state drive, a hard disk drive, a magnetic disk drive and/or an optical disk drive. The storage unit 214 may store data, for example, a knowledge documents database 250, a QA pairs database 255, and a citations database 260 among other data. In some examples, the storage unit 214 may serve as a database accessible by other components of the computing system 200. In some examples, the knowledge documents database 250, the QA pairs database 255, and/or the citations database 260 may be external to the computing system 200, for example the computing system 200 may communicate with an external system to access the various databases.

As will be discussed further below, the present disclosure describes an example RAG-based engine that provides a relevant source text (in particular, source text that has been retrieved based on a similarity of a user input embedding to a synthetic question embedding) to a LLM prior to prompting the LLM to generate output (e.g., an answer to a user query) for assisting a user.

FIG. 3 shows a block diagram of an example architecture for the RAG based engine 300, in accordance with examples of the present disclosure. The RAG based engine 300 may be a software that is implemented in the computing system 200 of FIG. 2, in which the processor 202 is configured to execute instructions of the RAG-based engine 300 stored in the memory 204.

The RAG-based engine 300 includes a user interface (UI) 302, a rephrase operator 304, a similarity engine 306, a retrieval module 308, an update detection module 310, a chunking operator 312, a QA generator module 314, a prompt generator 316 communicating with an LLM 318, and user input 301 as well as databases, including knowledge documents database 250, QA pairs database 255 having mapping table 257, and a citation database 260. It should be understood that the modules depicted in FIG. 3 are exemplary and not intended to be limiting. For example, the RAG-based engine 300 may include a greater or fewer number of modules than that shown. As well, operations described as being performed by a particular module may be additionally or alternatively performed by another subsystem. For example, operations of the similarity engine may be part of the operations of the retrieval module 308. Similarly, operations of the rephrase operator 304 may be part of the operations of the prompt generator 316. The RAG-based engine 300 may receive a user input 301 and generate a prompt for providing to an LLM 318 for generating a textual response 319 to the user input.

In examples, the user input 301 may be received by the RAG-based engine 300, for example, via the UI 302. In examples, the RAG-based engine 300 may be associated with a knowledge base search or a chatbot operation, among other applications. In examples, the user input 301 may be received as a textual input, for example, received via a textbox object in a knowledge base search UI or in a chat window in a chatbot UI, among others. In other examples, the user input 301 may be an audio input, for example, received via a microphone of computing system 200, or the user input 301 may be received in another format, for example, as a touch input, or the user input 301 may be received as a selection of an item (e.g., a topic or category, or another object) on a webpage of an e-commerce platform, among other inputs. In some embodiments, for example, the user input 301 may be phrased as a question (e.g., “how do I add a product to my online store?”) or the user input may not be phrased as a question. For example, a user input 301 may be phrased as a statement (e.g., “I'm trying to add a product to my online store”), a topic or category (e.g., “adding products to an online store”), or a keyword (e.g., “products”), or the user input may be phrased as a problem the user is experiencing (e.g., “I'm having trouble adding products to my online store”), among others.

In the context of using the RAG engine 300, user queries received via the user input 301 may be categorized into various types based on their nature and kind of information they seek. Some of the common types of queries can include: informational queries (e.g. seeking to understand the meaning of a term or concept); comparative queries (e.g. comparing features, benefits of different products or services); analytical queries (e.g. identifying and resolving issues or problems); exploratory queries (e.g. broad inquiries to explore a topic without a specific focus); decision making queries (e.g. requesting advice or recommendations to make decisions); transactional queries (e.g. requiring assistance with performing a specific action or transaction); navigational queries (e.g. seeking to find specific websites or online resources); factual queries (e.g. requesting precise information or data points); and descriptive queries (e.g. seeking detailed descriptions of objects, places or events). Generally, each type of query may leverage the RAG engine 300 capabilities to retrieve relevant documents and generate contextually appropriate, informative responses.

Generally, referring to FIG. 3, with the RAG engine 300, it provides an intelligent information retrieval component, that is able to apply the user input to retrieve information from a data source and to continually monitor the data sources for updated information, in such a way as to minimize utilization of computing resources by honing in on portions or segments of the data sources which have been updated thereby updating the question-answer pairs for those updated segments of the data sources such that the user query and the relevant information from the question answer pairs are both provided to the LLM 318 so that the LLM uses the query information, its initial training data and the updated question-answer pairs as relevant to the specific query to create better responses in the form of textual response 319.

The user query provided on the UI 302 may then be provided to a rephrase operator 304, configured to convert the query to a vector representation and apply a similarity engine 306 to determine a match of the query to one or more relevant question answer pairs stored in one or more databases, such as the QA pairs database 255. The QA pairs database 255 may also be linked to or the QA pairs otherwise having associated citations, in the citations database 260 indicating where or which portions of a knowledge document, as stored in a knowledge documents database 250, the QA pairs retrieved are based upon. The retrieval module 308 may be configured to search the QA pairs database 255 and retrieve the relevant QA pairs matching the query (e.g. via a similarity engine 306). In one or more examples, the QA pairs retrieved may be fed to the LLM 318, such as via a prompt generator 316 which may be configured to convert the questions into a similar format prompt as the initial query and then fed into a trained LLM 318 along with the query to generate a relevant textual response 319.

The RAG engine 300 may further comprise a QA engine 350, configured to access one or more knowledge documents database(s) 250 and generate therefrom one or more relevant question answer pairs based on the knowledge document and in some cases, associated citations or reference to portions or segments of the knowledge document from which the question and answer pairs are based. In the present disclosure, the QA engine 350 is specifically configured to continuously monitor whether there may be updates to a knowledge document in the knowledge documents database 250 via an update detection module 310, and cause, based on a determination of a change, to continuously update synthetic question and answer (QA) pairs, via a QA generator module 314 associated with the document in an intelligent and resource efficient manner. That is, the QA engine 350 may be configured to determine changes in the original and modified chunk pairs of a document by performing segmentation or chunking analysis on each of the current and prior iteration of the document via the chunking operator 312.

The QA engine 350 cooperates with the retrieval module 308, during the information retrieval stage as it generates the QA pairs, which may be stored in the QA pairs database 255 and possibly, associated citations in the citations database 260 referencing portions of the knowledge document from which the QA pairs are derived.

As noted earlier, the generation and management of QA pairs is a complex task, particularly when the source knowledge documents to be used to generate the QA pairs, such as help center articles, blogs, FAQs, etc. are frequently updated and the significance and nature of such updates may be unknown. As mentioned earlier, the relevance and usefulness of the LLM output generated, is based on the accuracy of the context provided by the RAG engine. If the QA pairs are outdated or obsolete, the accuracy of the textual response provided by the LLM is not useful or accurate.

In one or more examples, the knowledge documents as retrieved from the knowledge documents database 250, may be broken down into chunks via a chunking operator, and then transformed into QA pairs via a QA generator module 314 (which may pass them to an LLM with specific instructions and examples). Such chunks may refer to segments or smaller parts of text of a document that are identified and separated based on specific criteria, typically related to their syntactic or semantic structure. In one or more examples, when a knowledge document is updated, existing QA pairs associated with the document, which may be stored on the QA pairs database 255, may no longer be relevant to the updated information.

Moreover, identifying which QA pairs need to be deleted, updated, or added is a significant technical and computational challenge. Regenerating all the QA pairs for an updated document again, unnecessarily wastes computing resources and is unfeasible.

In an example implementation, upon the update detection module 310 detecting an update to the knowledge document, the QA engine 350 may match QA pairs to the sections of the knowledge document they were generated from and determine the significance of any changes to these sections. For example, upon generating QA pairs via the QA generator module 314, a mapping may be stored, within a mapping table 257 mapping sections or chunks of the knowledge document (e.g. via a reference citation) to corresponding question and answer pairs generated therefrom. Thus, when an update detection module 310 detects a change to a portion or chunk in the knowledge document, it may easily determine how the prior version of that chunk mapped to a question and answer pair thereby being able to determine a degree of change to the portion of the document and replace the prior question and answer pairs as necessary.

As disclosed herein, in examples, the RAG engine 300 is configured to automatically generate a response to a query, in the form of a textual response 319, the query posed by a user via user input 301, in a manner that retrieves more relevant and/or current source content from the knowledge documents in the knowledge documents database 250 for augmenting the LLM 318, and dynamically updates the system, e.g. the QA generator module 314, to generate more effective synthetic QA pairs such as to augment the LLM when the source knowledge documents (e.g. as stored in external data stores) are updated. That is, the RAG engine 300 may initially generate a set of QA pairs based on a knowledge document and in some examples, associated citations or references for those QA pairs from the knowledge document stored in the knowledge documents database 250. The QA engine 350 is configured to continually monitor and track the knowledge document and upon determining an update to one or more portions of the knowledge document, intelligently and selectively update relevant existing QA pairs, as may be stored in the QA pairs database 255 (which may be mapped to sections of a knowledge document from which they are generated from via a mapping table 257). For example, as will be described herein, such intelligent updating may include applying a chunking operator 312 to determine which particular segment(s) of the knowledge document from which a QA pair set is based upon has been updated and thereby only cause the QA generator module 314 to regenerate an updated QA pair within the QA pair set to replace an existing QA pair for that specific updated segment rather than regenerating the entire QA pair set for the document.

For example, at an initial iteration of the RAG engine 300, a source knowledge document (e.g. as stored in an external data store shown as a knowledge documents database 250) is transformed into question and answer pairs using a QA generator module 314 which may apply an LLM model to generate such pairs. The initial QA pair set may then be stored in a database, such as QA pairs database 255. Each synthetic question may be mapped to an answer from a portion of a content item in a corpus or the knowledge document, where an answer to the posed synthetic question may be reliably obtained from the content item. Then at inference stage of the RAG engine 300 and given a user query (e.g. user input 301 which may be received on a UI 302 such as related to an interactive Q/A system or chatbot), the RAG engine 300 rephrases the query into a question format (e.g. via a rephrase operator 304) and identifies a matching synthetic question in the database of the QA pairs database 255, using vector similarity algorithm searching via the similarity engine 306 and thereby retrieving the corresponding answer pair in the retrieval module 308.

Referring again to FIG. 3, the RAG engine 300 leverages the semantic understanding capabilities of an LLM to formulate more accurate and relevant synthetic question and answer pairs based on intelligently updating the QA pairs via the QA Generator module 314 upon detecting an update to the knowledge document, via the update detection module 310 from which the initial QA pairs are derived (as may be stored in QA pairs database 255), thereby improving the accuracy of the document retrieval for the retrieval module 308 in a subsequent iteration of the engine and response generation for the textual response 319.

In example implementations, the chunking process performed by the chunking operator 312 may perform the process of dividing a large corpus of text as may be provided in a knowledge document into smaller, manageable pieces or chunks of text. The type of chunking process performed may be predefined or dynamically determined based on a particular knowledge document and/or type of user input query. Such type of chunking may include fixed length segmentation such as dividing text into chunks of a predefined length or alternatively, semantic segmentation which may include applying natural language processing (NLP) techniques to split text based on semantic boundaries such as sentences, paragraphs, sections, section headers, etc. The semantic segmentation also referred to as context aware segmentation may be useful as it ensures chunks are meaningful and contextually complete. In preferred embodiments, the type of chunking applied is document structure aware and comprises semantic segmentation. The chunking technique applied by the chunking operator 312 is important for efficient retrieval and subsequent generation of responses in the RAG engine 300, which combines retrieval-based and generative approaches for more accurate and contextually relevant outputs, provided in the textual response 319.

Thus, once the update detection module 310 detects that a knowledge document has been modified, the chunking operator 312 may perform chunking operations on the modified document and the update detection module 312 may then be configured to compare the original and modified chunks to determine which particular chunks of texts were modified and how they map to one another.

For example, during the chunking process performed by the chunking operator 312, positional and/or content indexes may be created for each paragraph/section in the original and modified knowledge documents such as to easily cross reference one section or chunk of the original document to the modified version of the document's corresponding section or chunk. Such cross reference by applying indexing facilitates comparison between corresponding chunks in an original and modified knowledge document. Once the original and modified documents are broken down into chunks or segments, the update detection module 310 may be configured to thus perform a comparison between corresponding chunks of the different versions or iterations of the knowledge document. The comparison technique applied may include, but not limited to: hashing (calculating hash values for each chunk in both documents); and similarity metrics (e.g. for chunks with differing hashes, using various distance similarity measures such as cosine similarity, Jaccard index, Levenshtein distance or edit distance; word embeddings, transformer models, or other text similarity metrics). In one example, as may be described herein, the update detection module 310 may be configured to compare two corresponding chunks of text by initially performing a checksum function on each of a current version of the knowledge document and an original version to determine whether the two checksums for both chunks match indicating that the chunk texts are identical or that they don't match, indicating that the text has been altered and thus the further similarity metrics described herein may be applied for further comparison of the chunks.

In at least some preferred aspects, the flexibility of the chunking process applied by the chunking operator 312 based on document structure of the knowledge document rather than fixed sizes (e.g. semantic or document aware segmentation), enables small edits to the knowledge document (e.g. add or remove a word or two) to be unlikely to affect subsequent chunks which a fixed-length chunking mechanism would.

This improves the usefulness, as the significance assessment or other changes will only apply to changed chunks and not all chunks subsequent to the first change will have changed. In preferred embodiments, the chunking operator 312 applies document aware chunking process which processes metadata from the knowledge document is aware of section headers, subheaders, paragraph structure etc. which may be generated at the time of creating the source knowledge document and is then stored in a database for use by the chunking process such as to determine the chunk sizes based on the document structure metadata. This is a more dynamic approach to chunking and better aware of the context of the document so that related chunks may be stored within a single chunk. In some aspects, the method includes determining whether a portion of text preceding an assigned chunk (e.g. belonging to a prior chunk) contextually relates and has semantic similarities by applying NLP techniques, to a current chunk and thereby merging the two portions of text from the prior and current chunk to form a single chunk of related text thereby ensuring that content related to each other is grouped together in a single unified chunk. This process may be performed iteratively until optimal chunking is achieved. In this way, the QA pairs generated from a chunk, conveniently are able to utilize more text to determine the QA pairs and thus generate higher quality QA pairs.

Thus, the QA engine 350 is configured to specifically hone in on portions or chunks of the source knowledge document which have been updated by performing a chunking process applied by the chunking operator 312 and a comparison of the chunks by the update detection module 310, and then triggering the QA generator module 314 (e.g. an LLM) to generate new QA pairs for the updated chunks of the knowledge document only (rather than the entire knowledge document or article), thereby generating more relevant QA pairs which reflect the update specifically.

Further conveniently, in at least some aspects by triggering the QA generator module 314 to focus on regenerating the QA pairs for the modified chunks, this may, in at least some aspects, cause the LLM in the QA generator module 314 to focus in on the modified chunks for generating the additional QA pairs thereby generating additional or more focused QA pairs by biasing the LLM model to the modified chunks. Thus, in at least some aspects, the modified chunks may have multiple or additional QA pairs as compared to the initial chunk based on focusing the LLM model to regenerate the QA pair for the specific modification.

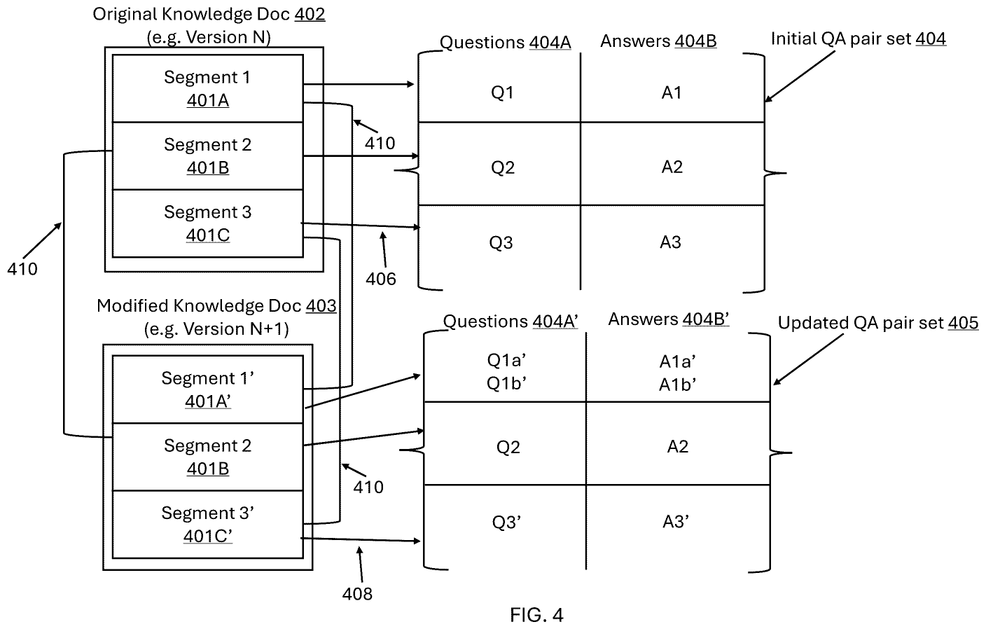

The new QA pairs for the modified chunks are then used to replace the QA pairs for the corresponding original chunk and then merged with the remaining original QA pairs for the remainder of the article/knowledge document to form the updated QA pair set that may be stored in the QA pairs database 255 (e.g. see also discussion in FIG. 4).

In some aspects, upon the QA engine 350 determining that a chunk in the knowledge document has been updated in a current version of the document, a subsequent method may be applied to determine the degree of change. For example, the update detection module 310 may assess a significance of the update made to the modified chunk (e.g. a measure of the degree of change) and apply a defined threshold or metric (e.g. similarity distance being beyond a specific threshold) to determine whether such degree of change should trigger the re-generation of the QA pair for the updated chunk via the QA generator module 314.

In some aspects, the LLM of the QA generator module 314 when generating the new QA pairs for the updated chunk within the knowledge document, also updates the citations or references for that updated chunk (e.g. reference or pointer to portions of the source document from which the QA pairs are generated) as may be stored in mapping table 257.

FIG. 4 illustrates in a schematic diagram an example sequence of an original knowledge document 402 (e.g. version N where N is a prior version number) and a modified knowledge document (e.g. version N+1 being a current version number) and corresponding question answer pair sets, e.g. an initial QA pair set 404 and an updated QA pair set 405.

In the example of FIG. 4, the original knowledge document is used to generate a set of questions 404A and corresponding answers 404B provided in an initial QA pair set 404 having a set of questions 404A and corresponding answers 404B. Each pair of question and answers may be mapped or otherwise linked, such as by initial references 406 to segments or portions of text within the original knowledge document, from which they are derived. For example, segment 1 401A may be used to generate the QA pair, Q1 and A1; whereas segment 2 401B may be used to generate QA pair Q2 and A2; and segment 3 401C may be used to generate QA pair Q3 and A3, shown by the initial references 406.

Furthermore, as shown in the lower portion of FIG. 4, the modified knowledge document 403 (e.g. version N+1), may result in an updated QA pair set 405, via the QA engine 350 of FIG. 3. Specifically the QA engine 350 of FIG. 3, may determine, such as by way of a checksum or initial hash that the document has been modified and then as described herein, determine that segments 1 and 3 have been modified (e.g. by way of the update detection module 310), the modified segments shown respectively as segment 1′ 401A′ and segment 3′ 401C′ and linked to modified QA pairs shown as questions 404A′ and answers 404B′ via updated references 408, generated via the QA generator module 314. The QA engine 350 may thus trigger the QA generator module 314 to specifically update and re-generate the QA pairs for particular modified segments, e.g. segment 1′ 401A′ and segment 3′ 401C′. As shown, segment 1′ 401A′ may result in QA pairs: Q1a′ and A1a′; and Q1b′ and A1b′ respectively thereby generating additional QA pairs than initially provided and segment 3′ 401C′ may result in updated QA pair set Q3′ and A3′. As shown in the updated QA pair set 405, the updated QA pairs may be merged or otherwise aggregated with the unchanged or initial QA pairs (e.g. Q2 and A2) to generate the updated set, which may then be provided to the LLM 318, such as by way of the prompt generator 316.

In examples, based on the user input 301 and the QA pair retrieved from the QA pairs database 255 as relevant to the user input, the prompt generator may generate a prompt to the LLM 380 (such as GPT-3, or an aggregation of multiple LLMs or other models), where the prompt instructs the LLM 318 (or multiple LLMs or other models) to generate a textual response 319 to the user input 301.

In this regard, examples of the present disclosure leverage the semantic understanding capabilities of the LLM 318 along with current source text based on a current or updated version of the knowledge document for generating QA pairs for augmenting the LLM 318, to enable the LLM 318 to generate more accurate and relevant textual responses 319 to the user input 301.

In examples, the generated textual response 319 may be provided for display via a user device. For example, the LLM 318 may be configured to cooperate with the textual response 319 on a display of a user device (e.g., the textual response 319 from the LLM 318 may be outputted to the RAG-based engine 300, to enable the textual response 319 to be presented via the UI 302). In some embodiments, for example, the RAG-based engine 300 may be associated with a web-based knowledge base or help center, and the textual response 319 may be displayed on a webpage of the knowledge base or help center.

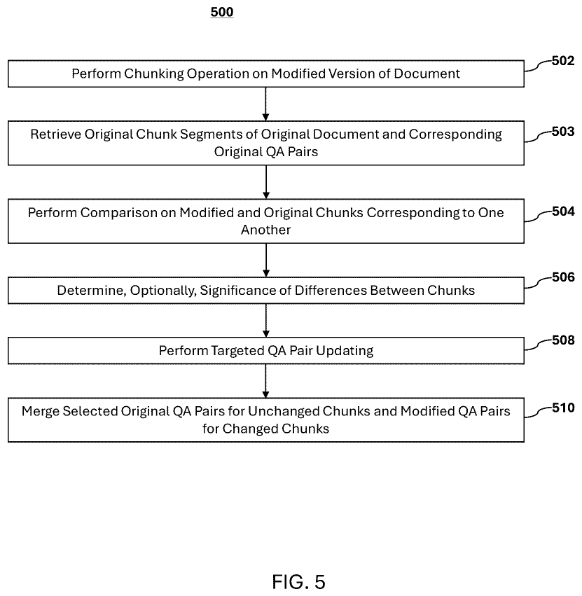

FIG. 5 is a flowchart of an example method 500 for operation of an example QA engine 350 of a RAG-based engine 300, in accordance with examples of the present disclosure. The method 500 may be performed by the computing system 200. For example, a processing unit of a computing system (e.g., the processor 202 of the computing system 200 of FIG. 2) may execute instructions (e.g., instructions of the RAG based engine 300) to cause the computing system to carry out the example method 500. The method 500 may, for example, be implemented by an online platform, or a server.

Initially, upon receiving an indication that an original knowledge document in the knowledge document database 250, from which a current set of QA pairs have been derived for augmenting the LLM 318, has been updated and/or modified (e.g. into a modified version of the knowledge document) the operation 502 may be triggered. At operation 502, the QA engine 350 may perform a chunking operation as described above for the modified version of the knowledge document on the updated article body or blog post content. The chunking operation may be performed by the chunking operator 312 and breaks down the modified document into segments or ‘chunks’ of a character or token limit suitable for text processing (e.g. by the LLM 318). Preferably, as described above, the chunking operator 312 processes metadata associated with the knowledge document and applies a document structure aware chunking method to divide the chunks based on structure of the document such as sections, paragraphs, heading, subheadings in HTML or another markup format. This document aware chunking may divide the modified text document into smaller, coherent segments or “chunks” while preserving the document's overall context and structure. Rather than a fixed length, the chunking operation may use an average length and a maximum length (e.g. values of 200 and 500). Conveniently, by leveraging the document's structure, document-aware chunking produces segments that are more relevant and contextually rich, facilitating more accurate and efficient text processing. Prior to operation 502, in at least some aspects, the original knowledge document has previously undergone a chunking operation and the chunks used to generate QA pairs, using an LLM provided in the QA generator module 314. The original QA pairs may be stored in the QA pairs database 255 and the association with the chunks or segments in the original document may be stored in the mapping table 257 of the citation database 260. An example of such mapping between segments and the initial QA pair set is shown in FIG. 4.

At operation 503, the QA engine 350 may thus retrieve, via the retrieval module 308, the original chunk sets from the original knowledge document and the corresponding QA pairs derived therefrom. The QA engine 350 may then be configured to determine, based on the document structure information provided in the original and modified document metadata as to how the original and modified chunks correspond to one another. As noted earlier, the boundaries and features of the knowledge document may be used to map one chunk to another such as the header, paragraph number, headings, sections, etc. Such chunk mapping 410 is shown in the example of FIG. 4 between each segment from the original knowledge document and the modified knowledge document (e.g. segment 1 401A mapping to segment 1′ 401A′; segment 2 401B mapping to segment 2 401B; segment 3 401C mapping to segment 3′ 401C′).

At operation 504, the QA engine 350 may be configured to compare the initial and modified chunks corresponding to the initial and modified documents using various similarity measures as described above. Such similarity metrics may include but not limited to a checksum generated using a hash function. For example implementations, for each modified and original chunk pair of current and prior iteration of the knowledge document, the update detection module 310 may be configured to calculate a checksum to determine whether there is a difference between the existing chunk and the chunk from the previous version of the document. Such comparison performed at operation 504 may involve hashing techniques such as MD5 or SHA-256.

At operation 506, optionally, the QA engine 350 may be configured to perform a significance assessment determining a degree of change between the original and modified text chunks. Such ways of comparing the modified chunk to the original chunk may be envisaged as described herein with respect to FIG. 3, and may include but not limited to exact match comparison (comparing the text chunks character by character or word by word) to determine amount of change; token-based comparison (tokenize the text into words or sentences and compare the tokens); edit distance or Levenshtein distance (determine number of edits such as insertions, deletions, substitutions required to transform one text chunk into the other); cosine similarity; Jaccard similarity; semantic similarity; etc.

Alternatively, the QA engine 350 may determine differences between modified and original chunks by performing semantic similarity measures such as cosine similarity on embeddings of the chunks. Other NLP techniques may be used to determine the nature of the difference between the modified chunk and the original chunk. Additionally or alternatively, machine learning approaches may be considered. For example, an ML model trained on previous changes and their impact on QA pairs, may be used to predict whether a change is significant enough to warrant a QA pair update in operation 508.

Thus, at operation 506, a measure or significance of the change between each modified chunk and corresponding original chunk may be determined. The QA engine 350 may use features such as the magnitude of change in the vector space, the number of changed words, the change in semantic similarity score, etc. and compare same to a predefined threshold or metric to determine whether the amount or degree of change is significant enough to trigger an update of the QA pairs in operation 508.

At operation 508, following either operation 506 or 504, the QA engine 350 may be configured to perform a targeted QA pair updated. That is, as described earlier, the targeted QA pair update may only cause the QA generator module 314 to generate new QA pairs only for the modified chunks and replace the existing QA pairs for the corresponding chunks. In some aspects, the targeted QA pair update may only cause generating the new QA pairs if the difference metric or significance metric of the change is beyond a certain defined threshold.

In an example implementation, if a chunk is modified, the update detection module 310 may execute a check to determine whether the modified section or chunk of the knowledge document, as may be retrieved via the retrieval module 308, has any associated QA pairs, such as by checking the mapping table 257 to determine the citations to the QA pairs. For example, if the modified section has a citation or reference in a mapping table for at least one QA pair, the QA generator module 314 may regenerate only those specific QA pairs for the modified section and merge with the original QA pairs of the unmodified chunks at operation 510.

In some examples, the QA generator module 314 may delete a previously generated QA pair based on the modification to the corresponding chunk. In some cases, the original QA pair may be modified by passing it as input to a large language model (e.g. as may be provided by the QA generator module 314) alongside the newly modified section of the chunk to generate one or more new QA pairs for the modified chunk.

As described earlier with reference to FIG. 3, the updated QA pairs may be fed to the LLM 318 along with the user input 301 to generate a textual response 319.

In example implementations of the RAG engine 300, when QA pairs are initially generated from a particular chunk of a document or resource, the RAG engine 300 may be configured to store a citation or reference to exact portions or substrings of the particular chunk that each QA pair was derived from via the QA generator module 314. Such citations may be stored within a mapping table 257 in the citations database 260. Each citation acts as a ‘pointer’ to the source of the QA pair within a given chunk of the document, enabling precise tracking of QA pair origins. This also allows the QA engine 350 to easily update QA pairs, via the update detection module, as when a new set of QA pairs is generated for a modified chunk and it is known how the modified chunk maps to an original chunk of a prior iteration (e.g. via the document structure metadata including headers, etc. or NLP techniques) as well as how the original chunk maps to original QA pairs using the citations stored in the mapping table, then the new set of QA pairs can easily replace the original QA pairs for related chunks in different versions of the document.

For example, a prompt may be generated via the prompt generator 316 for the LLM 318, where the prompt instructs the LLM 318 to generate a textual response 319 to the user input 301 based on the QA pair information retrieved from the databases, such as the QA pairs database 255.

In another example, the textual response 319 may be provided for display via a user device. For example, the LLM 318 may be configured to cooperate with the UI 302 for displaying the textual response 319 on a display of a user device.

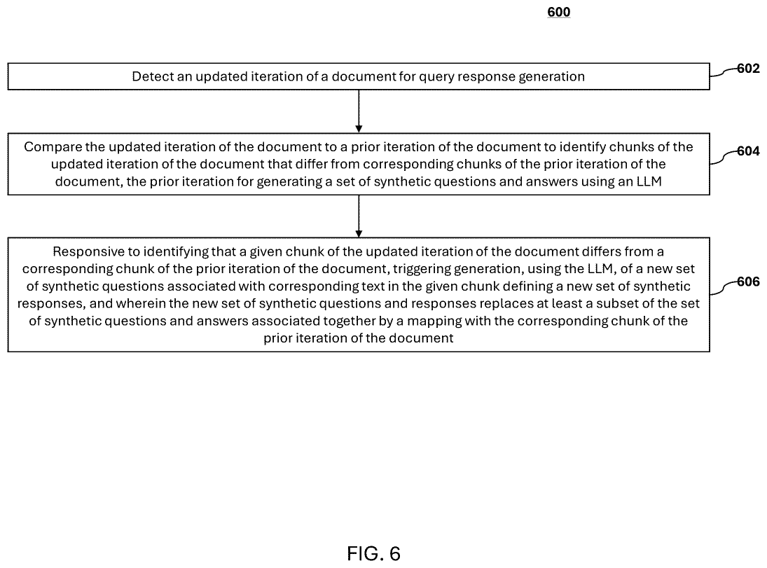

FIG. 6 is another flowchart of an example method 600 which may be performed by the RAG engine 300, in accordance with examples of the present disclosure. The method 600 may be performed by the computing system 200. For example, a processing unit of a computing system (e.g., the processor 202 of the computing system 200 of FIG. 2) may execute instructions (e.g., instructions of the RAG-based engine 300) to cause the computing system to carry out the example method 600.

In some aspects, one or more of the method operations or steps 600 of FIG. 6 may be combined or interchanged with one or more computing steps of the method steps 500 of FIG. 5.

At an operation 602, an updated iteration of a knowledge document for generating synthetic question and answer pairs may be detected, whereby a prior set of synthetic question and answer pairs was generated based on the prior iteration of the knowledge document, using an LLM as may be provided by the QA generator module 314. For example, such detection may include the RAG engine 300 using timestamps to track last modification time of the document and the update detection module 310 checking the metadata of the document to determine the last modified timestamp to compare it to the previous timestamp stored in the knowledge documents database of FIG. 3.

At an operation 604, a comparison may be performed by the update detection module 310 between the updated iteration of the document and a prior iteration of the document to identify chunks or segments of the updated iteration that differ from corresponding chunks of the prior iteration of the knowledge document. This may include, for example, as defined in operations 502-504 of FIG. 5 of performing chunking operations on the updated and prior iterations of the document, and based on a mapping or correlation between the chunks performing a comparison, such as by way of hashing or other natural language processing techniques described herein to determine which of the chunks or segments of text has been updated and whether a new QA pair set should be regenerated for the updated chunk (e.g. if the distance measure indicates a significant degree of change between the original and updated chunk).

At an operation 606, in response to determining that one or more chunks of the updated document have changed with respect to their counterpart chunks in the original document, the RAG engine 300 may trigger the LLM provided in the QA generator module 314 to generate new set of synthetic question and answer pairs (e.g. QA pairs) for the updated chunks (e.g. see FIG. 4 as example) and replace the prior set of QA pairs for the counterpart chunk in the original document. That is, the QA pairs for the updated chunks, as generated in the current iteration by the LLM may be combined with the QA pairs for the unmodified chunks, previously generated by the LLM to define an aggregated QA pair set (e.g. see updated QA pair set 405 in FIG. 4 having some new and some overlapping QA pairs as compared to the initial QA pair set 404.

In examples, the updated chunk may instruct the LLM provided by the QA generator module 314 to generate possible questions where answers to the one or more possible questions can be found in the updated chunk of the updated source text. Note that the LLM provided in the QA generator module 314 as described herein may be a same or additional LLM to the LLM 318.

Examples of the present disclosure may enable more accurate response generation by an LLM, for example, by enabling more updated sources of information and corresponding QA pair generation in an intelligent and efficient manner for use by an LLM in generating responses. Such intelligent updating of QA pairs for RAG based augmentation of the LLM by honing in on specific QA pairs to update based on determining modified chunks and corresponding citations to QA pairs and only updating the QA pairs for the modified chunks reduces the unnecessary consumption of computing resources (e.g., processing power, memory, computing time, etc.) associated with performing adhoc QA pair generation or QA pair regeneration of an entire document when a knowledge document is updated to achieve a desired result from the LLM.

A RAG based engine as disclosed herein may be used in various implementations, such as on a website, a portal, a software application, etc. In an example, the disclosed RAG-based engine may be implemented on an e-commerce platform, for example to assist a user (e.g., a merchant, store owner or store employee) in providing answers to specific questions related to operation of the e-commerce platform.

For example, the RAG-based engine as disclosed herein may be provided as an engine of the e-commerce platform. A user may interact with the e commerce platform via a user device (e.g., a merchant device or a customer device, generally referred to as a user device) to provide user input and receive a textual response as described above.

Although the present disclosure has described a LLM in various examples, it should be understood that the LLM may be any suitable language model (e.g., including LLMs such as LLaMA, Falcon 40B, GPT-3, GPT-4 or ChatGPT, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Various embodiments have been described. These and other embodiments are within the scope of the following claims.

1. A computer-implemented method comprising:
detecting, by a computing device, an updated iteration of a source document;
comparing, by the computing device, the updated iteration of the source document to a prior iteration of the source document to identify a given chunk of the updated iteration of the source document that differs from the corresponding chunk of the prior iteration of the source document, the prior iteration for generating a set of synthetic question and answer pairs using a large language model (LLM); and
responsive to identifying that the given chunk of the updated iteration of the source document differs from the corresponding chunk of the prior iteration of the source document, triggering generation, using the LLM, of a new set of synthetic question and answer pairs associated with corresponding text in the given chunk, and wherein the new set of synthetic question and answer pairs replaces at least a subset of the set of synthetic question and answer pairs associated with the source document, based on a mapping of the given chunk with the corresponding chunk of the prior iteration of the source document.

2. The method of claim 1, further comprising: applying the new set of synthetic question and answer pairs to the LLM to generate a response to a user query.

3. The method of claim 2 wherein generating the response further comprises:
applying the LLM to generate a textual response to the user query responsive to identifying a similarity to at least one of the set of synthetic question and answer pairs and the new set of synthetic question and answer pairs.

4. The method of claim 1, wherein triggering generation is further based upon detecting a degree of difference between the corresponding chunk and the given chunk exceeds a defined threshold.

5. The method of claim 1, wherein responsive to detecting the difference, further applying semantic similarity using natural language processing to determine a similarity measure and specific segments of text within the given chunk which are modified compared to the corresponding chunk in the prior iteration and triggering the generation of the new set of synthetic question and answer pairs for the specific segments of text.

6. The method of claim 1, further comprising:
prior to performing a comparison, performing an initial checksum on entire textual content of the updated iteration of the source document to determine whether an update exists in textual content of the source document as a whole and based on said determining, computing a hash on each chunk of the updated iteration and comparing the hash on each chunk to a corresponding chunk of the prior iteration of the source document to determine differing chunks for generating the new set of synthetic questions and answers therefrom.

7. The method of claim 4, wherein the degree of difference is based on at least one of a distance measure or a cosine similarity.

8. The method of claim 3, further comprising, providing a user interface configured to receive the user query and, in response, determining a similarity between the user query and the set of synthetic questions and the new set of synthetic questions to retrieve corresponding synthetic answers for providing the textual response to the user query and displaying the textual response on a visual display of the user interface.

9. The method of claim 1, wherein comparing further comprises initially performing content aware chunking on the updated iteration and prior iteration of the source document by accessing document metadata comprising document structure relationships providing at least one of section headers, subheaders and document boundaries, and chunking based on the document structure relationships, the chunking for identifying differing chunks between the updated iteration and prior iteration.

10. The method of claim 9, wherein chunking based on the document structure relationships, further comprises, prior to performing the chunking, determining, via natural language processing, whether one or more sentences corresponding to a prior chunk and preceding a current chunk has a similar context and thereby merging the prior chunk and the current chunk into a single chunk for comparing between iterations.

11. The method of claim 3, wherein generating the textual response to the user query comprises:
generating a prompt to the LLM, the prompt including the user query and a relevant set of question and answer pairs comprising: at least one of the set of synthetic question and answer pairs and the new set of synthetic question and answer pairs; and
providing the prompt to the LLM and receiving the generated textual response.

12. A computer system comprising:
a processing unit configured to execute computer readable instructions to cause the computer system to:
detect an updated iteration of a source document;
compare the updated iteration of the source document to a prior iteration of the source document to identify a given chunk of the updated iteration of the source document that differs from the corresponding chunk of the prior iteration of the source document, the prior iteration for generating a set of synthetic question and answer pairs using a large language model (LLM); and
responsive to identifying that the given chunk of the updated iteration of the source document differs from the corresponding chunk of the prior iteration of the source document, trigger generation, using the LLM, of a new set of synthetic question and answer pairs associated with corresponding text in the given chunk, and wherein the new set of synthetic question and answer pairs replaces at least a subset of the set of synthetic question and answer pairs associated with the source document, based on a mapping of the given chunk with the corresponding chunk of the prior iteration of the source document.

13. The computer system of claim 12, wherein the processing unit is further configured to execute computer readable instructions to cause the computer system to: apply the new set of synthetic question and answer pairs to the LLM to generate a response to a user query.

14. The computer system of claim 13 wherein in generating the response the processing unit is further configured to execute computer readable instructions to cause the computer system to:
apply the LLM to generate a textual response to the user query responsive to identifying a similarity to at least one of the set of synthetic question and answer pairs and the new set of synthetic question and answer pairs.

15. The computer system of claim 12, wherein triggering generation is further based upon detecting a degree of difference between the corresponding chunk and the given chunk exceeds a defined threshold.

16. The computer system of claim 12, wherein responsive to detecting the difference, the processing unit is further configured to execute computer readable instructions to cause the computer system to further apply semantic similarity using natural language processing to determine a similarity measure and specific segments of text within the given chunk which are modified compared to the corresponding chunk in the prior iteration and trigger the generation of the new set of synthetic question and answer pairs for the specific segments of text.

17. The computer system of claim 12, wherein the processing unit is further configured to execute computer readable instructions to cause the computer system to:
prior to performing a comparison, perform an initial checksum on entire textual content of the updated iteration of the source document to determine whether an update exists in textual content of the source document as a whole and based on said determining, compute a hash on each chunk of the updated iteration of the source document and comparing the hash on each chunk to a corresponding chunk of the prior iteration of the source document to determine differing chunks for generating the new set of synthetic question and answer pairs therefrom.

18. The computer system of claim 15, wherein the degree of difference is based on at least one of a distance measure or a cosine similarity.

19. The computer system of claim 14, wherein the processing unit is further configured to execute computer readable instructions to cause the computer system to:
provide a user interface configured to receive the user query and, in response, determine a similarity between the user query and the set of synthetic questions and the new set of synthetic questions to retrieve corresponding synthetic answers to provide the textual response to the user query and display the textual response on a visual display of the user interface.

20. The computer system of claim 12, wherein comparing further comprises initially performing content aware chunking on the updated iteration and prior iteration of the source document by accessing document metadata comprising document structure relationships providing at least one of section headers, subheaders and document boundaries, and chunking based on the document structure relationships, the chunking for identifying differing chunks between the updated iteration and prior iteration.

21. The computer system of claim 20, wherein in chunking based on the document structure relationships, the processing unit is further configured to execute computer readable instructions to cause the computer system to:
prior to performing the chunking, determine, via natural language processing, whether one or more sentences corresponding to a prior chunk and preceding a current chunk has a similar context and thereby merge the prior chunk and the current chunk into a single chunk for comparing between iterations.

22. The computer system of claim 14, wherein in generating the textual response to the user query, the processing unit is further configured to execute computer readable instructions to cause the computer system to:
generate a prompt to the LLM, the prompt including the user query and a relevant set of question and answer pairs comprising: at least one of the set of synthetic question and answer pairs; and the new set of synthetic question and answer pairs; and
provide the prompt to the LLM and receive the generated textual response.

23. A non-transitory computer-readable medium storing instructions that, when executed by a processing unit of a computing system, cause the computing system to:
detect an updated iteration of a source document;
compare the updated iteration of the source document to a prior iteration of the source document to identify a given chunk of the updated iteration of the source document that differs from the corresponding chunk of the prior iteration of the source document, the prior iteration for generating a set of synthetic question and answer pairs using a large language model (LLM); and
responsive to identifying that the given chunk of the updated iteration of the source document differs from the corresponding chunk of the prior iteration of the source document, trigger generation, using the LLM, of a new set of synthetic question and answer pairs associated with corresponding text in the given chunk, and wherein the new set of synthetic question and answer pairs replaces at least a subset of the set of synthetic question and answer pairs associated with the source document, based on a mapping of the given chunk with the corresponding chunk of the prior iteration of the source document.
